(19) United States
(12) Patent Application Publication
(10) Pub. No.: US 2018/0012225 A1
(43) Pub. Date: Jan. 11, 2018

(54) REDUCING AUTHENTICATION REQUIREMENTS FOR DATA TRANSMISSIONS

(71) Applicant: Alibaba Group Holding Limited, George Town (KY)

(72) Inventor: Yongping Chen, Hangzhou (CN)

(73) Assignee: Alibaba Group Holding Limited, George Town (KY)

(21) Appl. No.: 15/693,872

(22) Filed: Sep. 1, 2017

Related U.S. Application Data
(63) Continuation of application No. PCT/CN2016/074419, filed on Feb. 24, 2016.

(30) Foreign Application Priority Data
Mar. 2, 2015 (CN) 201510093345.0

(51) Int. Cl. G06Q 20/40; G06Q 20/10; G06F 21/62; G06Q 20/08

(52) U.S. Cl. CPC G06Q 20/4014; G06Q 20/10; G06F 21/6245; G06Q 20/0855

(57) ABSTRACT

A method of reducing authentication requirements for data transmissions includes receiving a request for a data transmission between a sender and a receiver. The request includes an amount of data associated with the data transmission. An overall confidence level is determined between the receiver and the sender. A data transmission protection mechanism is selected based on the overall confidence level between the receiver and the sender. The data transmission is performed based on the selected data transmission protection mechanism.

### CROSS REFERENCE TO RELATED APPLICATIONS

This application is a continuation of PCT Application No. PCT/CN2016/074419, filed on Feb. 24, 2016, which claims priority to Chinese Application No. 201510093345.0, filed on Mar. 2, 2015, the entire contents of each which are hereby incorporated by reference.

### BACKGROUND

For secure data transmissions between users, a sender or a receiver may need to be authenticated before the data is transmitted. For example, authentication information, such as passwords or biometric information may need to be provided. Usually a similar procedure is used for authentication operations, regardless of an amount of data to be transmitted. In some instances, when an amount of data is small, it takes more time to authenticate the sender or the receiver than to transmit the data between the sender and the receiver. In a case where a sender sends data to multiple receivers and each receiver needs to be authenticated, delay from authentication can cause poor user experiences.

### SUMMARY

The present disclosure describes reducing authentication requirements for data transmissions.

In an implementation, a request is received for a data transmission between a sender and a receiver. The request includes an amount of data associated with the data transmission. An overall confidence level is determined between the receiver and the sender. A data transmission protection mechanism is selected based on the overall confidence level between the receiver and the sender. The data transmission is performed based on the selected data transmission protection mechanism.

The previously described implementation is implementable using a computer-implemented method; a non-transitory, computer-readable medium storing computer-readable instructions to perform the computer-implemented method; and a computer-implemented system comprising a computer memory interoperably coupled with a hardware processor configured to perform the computer-implemented method/the instructions stored on the non-transitory, computer-readable medium.

The subject matter described in this specification can be implemented in particular implementations, so as to realize one or more of the following advantages. First, the described approach enables more efficient data transmissions by reducing authentication requirements (for example, the number and types of procedures performed to authenticate data transmissions). For example, a data transmission between a sender and a receiver can be performed without authenticating the sender or the receiver if an amount of data to be transmitted is lower than a threshold determined based on data transmission histories of the sender and the receiver. Second, reducing authentication requirements can save computing network resources by reducing the need for authentication messages. For example, network bandwidth can be reserved for non-authentication message transmission and computing power can be reserved for non-authentication message processing. Third, reducing authentication requirements can also enhance user experiences. For example, in some cases, users can spend little to no time entering authentication information (such as, passwords or biometric information) for data transmissions. Fourth, the described approach provides secured data transmission by requiring authentication if an amount of data to be transmitted exceeds a threshold. Other advantages will be apparent to those of ordinary skill in the art.

The details of one or more implementations of the subject matter of this specification are set forth in the Detailed Description, the claims, and the accompanying drawings. Other features, aspects, and advantages of the subject matter will become apparent from the Detailed Description, the claims, and the accompanying drawings.

### DESCRIPTION OF DRAWINGS

FIG. 1 is a flowchart illustrating an example method for reducing authentication requirements for data transmissions, according to an implementation of the present disclosure.

FIG. 2 is a flowchart illustrating an example method for determining an overall confidence level between a sender and a receiver, according to an implementation of the present disclosure.

FIG. 3 is a block diagram illustrating an example computer system used to provide computational functionalities associated with described algorithms, methods, functions, processes, flows, and procedures as described in the instant disclosure, according to an implementation of the present disclosure.

Like reference numbers and designations in the various drawings indicate like elements.

### DETAILED DESCRIPTION

The following detailed description describes reducing authentication requirements for data transmissions, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

At a high-level, the described approach enables efficient data transmissions in a computing network by reducing authentication requirements for data transmissions. The computing network can include multiple user computing devices (for example, mobile phones, personal computers, or tablet computers) connected to one or more servers using wired or wireless network connections. A user (for example, a sender) of a user computing device can send data to another user (for example, a receiver) of another user computing device through the computing network. In some implementations, information associated with data transmissions occurring in the computing network is recorded. For example, for each data transmission that occurs, an amount of transmitted data, a time of the data transmission, a sender's identity (for example, a user account ID), a sender's user computing device identity (for example, an IP or MAC address), a receiver's identity, a receiver's user computing device identity, and other information can be recorded.

When a sender wants to transmit data to a receiver, the sender's user computing device can send a data transmission request to a server. The server can determine a confidence level between the sender and the receiver based on, for example, the data transmission records of the sender or the receiver (or both). In some implementations, the confidence level can have the same unit as an amount of data, for example, byte (B) or gigabyte (GB). If an amount of data to be transmitted is more than the determined confidence level, authentication is performed for the sender, or the receiver, or both the sender and receiver. For example, the server can require that the sender, the receiver, or both the sender and receiver enter passwords or biometric information (such as, fingerprints, handprints, facial scans, retinal scans, and the like). However, if an amount of data to be transmitted between the sender and the receiver is equal to or less than the determined confidence level, the data can be transmitted without authentication of the sender, the receiver, or both the sender and the receiver.

The transmitted data can be of any type or in any format, such as textual, image, audio, binary, hexadecimal, encrypted, or compressed data. Generally, the amount of data is considered to be the size of the data. For example, if the transmitted data is a computer file, the amount of data can be considered to be the size of the computer file in bytes. In some implementations, as will be discussed below, the amount of data may not be considered to be the actual size of the data, but, instead, related to information carried within the data. For example, if the data transmission represents a fund transfer between two users, the amount of data can be an amount of funds to be transferred.

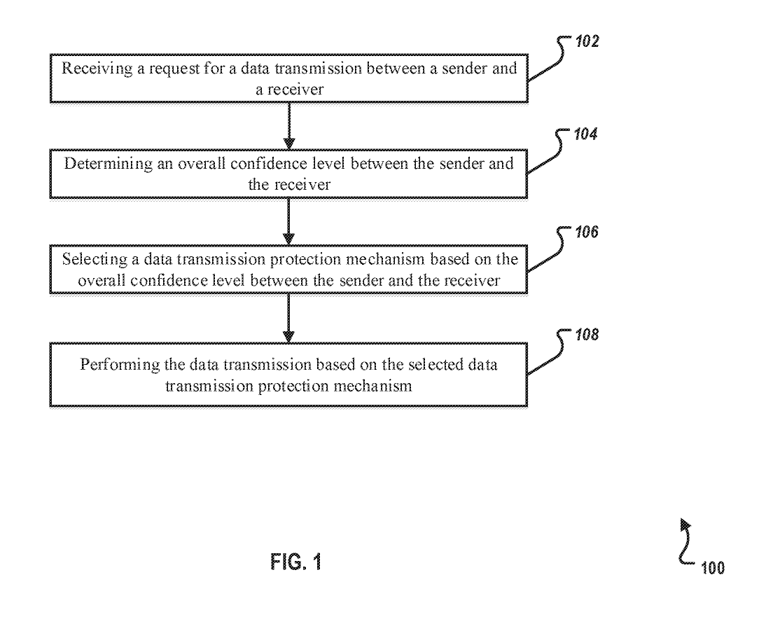

FIG. 1 is a flowchart illustrating an example method 100 for data transmissions with reduced authentication, according to an implementation of the present disclosure. For clarity of presentation, the description that follows generally describes method 100 in the context of the other figures in this description. However, it will be understood that method 100 may be performed, for example, by any suitable system, environment, software, and hardware, or a combination of systems, environments, software, and hardware, as appropriate. In some implementations, various steps of method 100 can be run in parallel, in combination, in loops, or in any order.

At 102, a server receives a request for a data transmission between a sender and a receiver. For example, the sender's user computing device can send the request to the server. The request can include the sender's identity (for example, a user account ID), the receiver's identity, an amount of the data to be transmitted, a format of the data to be transmitted, and other information. From 102, method 100 proceeds to 104.

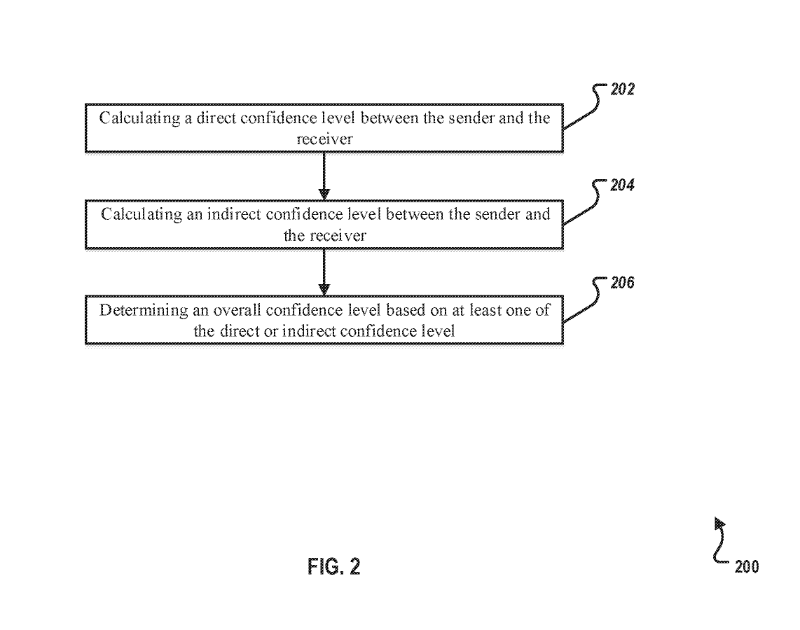

At 104, after receiving the data transmission request, the server determines an overall confidence level between the sender and the receiver. In some implementations, information associated with data transmissions occurring in a computing network can be recorded. For example, for each data transmission, a sender's identity (for example, a user account ID), an identity of the sender's user computing device (for example, an IP or MAC address), a receiver's identity, an identity of the receiver's user computing device, a starting time and an ending time of the data transmission, an amount of transmitted data, and other information can be recorded. As will be discussed in FIG. 2, the overall confidence level between the sender and the receiver can be determined based on the recorded information associated with data transmissions. For example, the overall confidence level can be determined by calculating a direct confidence level and an indirect confidence level, where the direct confidence level is calculated based on data transmissions between the sender and the receiver, while the indirect confidence level is calculated based on data transmissions between the sender and a third party and data transmissions between the receiver and the third party.

In some implementations, the overall confidence level, the direct confidence level, and the indirect confidence level can have the same unit as an amount of data, for example, in B or GB. In some implementations, instead of the overall confidence level having the same unit as an amount of data, the overall confidence level can be a number without any unit. For example, the overall confidence level can have 5 levels (such as, level 1 to level 5), where level 5 allows a data amount of more than 10 GB to be transmitted without authentication, level 4 allows a data amount of 1 GB to 10 GB to be transmitted without authentication, level 3 allows a data amount of 100 MB to 1 GB to be transmitted without authentication, level 2 allows a data amount of 1 MB to 100 MB to be transmitted without authentication, and level 1 requires authentication for all data transmissions regardless of the data amount. In some cases, the overall confidence level can be considered to be high if frequent data transmissions have occurred between the sender and the receiver. The overall confidence level can also be considered to be high if the sender and the receiver are from, for example, the same user group.

In some implementations, the server can calculate the overall confidence level, the direct confidence level, and the indirect confidence level in advance (for example, before the server receives the data transmission request) or upon receiving the data transmission request. The calculated confidence levels can be stored at the server. Storage of the confidence levels typically takes a small amount of memory space because the confidence levels are simple numbers. In some cases, the sender's user computing device can calculate the overall confidence level, the direct confidence level, and the indirect confidence level upon sending the data transmission request. The sender's user computing device can send the calculated overall confidence level to the server.

FIG. 2 is a flowchart illustrating an example method 200 for determining an overall confidence level between a sender and a receiver, according to an implementation of the present disclosure. For clarity of presentation, the description that follows generally describes method 200 in the context of the other figures in this description. However, it will be understood that method 200 may be performed, for example, by any suitable system, environment, software, and hardware, or a combination of systems, environments, software, and hardware, as appropriate. In some implementations, various steps of method 200 can be run in parallel, in combination, in loops, or in any order.

At 202, the server calculates a direct confidence level between the sender and the receiver. In some implementations, the direct confidence level can be calculated based on the recorded information associated with data transmission records between the sender and the receiver during a particular time period (for example, one year prior to the server receiving the data transmission request). The time period associated with the direct confidence level (such as, a starting time, an ending time, and a duration) can be configured by a system operator, the sender, the receiver, or others.

Based on the time information and the sender/receiver identity information recorded in historical data transmission records, the server can identify that data transmissions occurred between the sender and the receiver within the time period. Based on the data transmission records, the server can also determine the following quantities:
N₁: a number of times the sender transmitted data to the receiver in the time period.
V₁: an amount of data transmitted from the sender to the receiver in the time period. In some instances, V₁ can be an average or a total amount of data of the N₁ data transmissions.
N₂: a number of times the receiver transmitted data to the sender in the time period.
V₂: an amount of data transmitted from the receiver to the sender in the time period. In some instances, V₂ can be an average or a total amount of data of the N₂ data transmissions.

In some implementations, trust coefficients between the sender and the receiver can be calculated. For example, a direct trust coefficient can be calculated based on data transmissions between the sender and the receiver, while an indirect trust coefficient, as will be discussed in 204, is calculated based on data transmissions between the sender and a third party and data transmissions between the receiver and the third party. The direct and indirect trust coefficients can be a value between 0 and 1.

In some instances, the direct trust coefficient T_{direct} can be determined based on whether the total number of data transmissions between the sender and the receiver that occurred in a time period exceeds a threshold N. For example, when N₁+N₂≧N, the direct trust coefficient between the sender and the receiver is set to T_{direct}=1, and when N₁+N₂<N, the trust coefficient is set to T_{direct}=(N₁+N₂)/N. In other words, if the total number of data transmissions between the sender and the receiver in the time period is equal to or more than the threshold, a trust coefficient value of 1 is assigned. Otherwise, a small trust coefficient (less than 1) is assigned.

In some implementations, the threshold N can be statically or dynamically configured by the system operator, the sender, the receiver, or others. For example, N can be a static pre-set value. In some implementations, N can a dynamic value. For example, N can be a weighted average number of data transmissions in a network during a certain time period. For instance, assume that 10000 users are in the network. Among the 10000 users and during the certain time period, K1 users had 1 or 2 times the amount of data transmissions, K2 users had 3, 4, or 5 times the amount of data transmissions, K3 users had 6, 7, 8, or 9 times the amount of data transmissions, and K4 users had more than 10 times the amount of data transmissions. In this cases, N can be calculated as N=C1*K1+C2*K2+C3*K3+C4*K4, where C1 , C2, C3, and C4 are weighting values.

In some implementations, the direct confidence level C_{direct} between the receiver and the sender can be calculated based on the direct trust coefficient and amounts of data associated with data transmissions that have occurred. For example, in some instances, C_{direct}=(V₁+V₂)*T_{direct}/2, that is, the direct confidence level, is calculated as an average amount of transmitted data between the sender and the receiver multiplied by the trust coefficient. Other mathematical functions consistent with this disclosure can also be used to calculate the direct confidence level.

As a particular example, assume that the time period is one year prior to the server receiving the data transmission request. If in the year preceding the data transmission request the sender transmitted data to the receiver twice (N₁=2), and corresponding data amounts, are 5 megabyte (MB) and 15 MB, then V₁=(5+15)/2=10 MB (assuming that V₁ is the average data amount of the N₁ transmissions). Further, if in the year preceding the data transmission request the receiver transmitted data to the sender four times (N₂=4), and corresponding data amounts are 20 MB, 20 MB, 15 MB, and 25 MB, then V₂=(20+20+15+25)/4=20MB (assuming that V₂ is the average data amount of the N₂ transmissions). If the threshold is considered to be N=10, the direct trust coefficient T_{direct}=(2+4)/10=0.6, and the direct confidence level C_{direct}=(10+20)*0.6/2=9 MB From 202, method 200 proceeds to 204.

At 204, the server calculates an indirect confidence level between the sender and the receiver. For calculating the indirect confidence level, a third party can be identified that engaged in data transmissions with both the sender and the receiver. In some instances, the sender and the receiver may not have a direct confidence level or have a zero direct confidence level because of no data transmissions occurring between the sender and the receiver during the time period associated with the direct confidence level. In these instances, an indirect confidence level provides a confidence level between the sender and the receiver through the third party. Even if the sender and the receiver have a direct confidence level, an indirect confidence level can also be calculated so that, as will be discussed in 206, the overall confidence level is based on both the direct and the indirect confidence levels. In some other instances, if the sender and the receiver have a direct confidence level, then the indirect confidence level is not calculated or set as zero. In some implementations, an indirect confidence level can be calculated even if the sender and the receiver do not have a direct confidence level or have a zero direct confidence level. In some implementations, if neither a direct confidence level nor an indirect confidence level exists (for example, no third party can be found for calculating the indirect confidence level), or if both the direct and indirect confidence levels are zero, authentication is performed for the sender or the receiver.

Similar to the direct confidence level, in some implementations, the indirect confidence level can be calculated based on data transmissions occurring during a particular time period. The time period associated with the indirect confidence level can be configured by a system operator, the sender, the receiver, or others. The time period associated with the indirect confidence level can be the same as or different than the time period associated with the direct confidence level.

For example, assume that the time period associated with the indirect confidence level is one year prior to the server receiving the data transmission request. Assume that during the year preceding the data transmission request the sender had no data transmission with the receiver. However, the sender had a data transmission with User C three months prior to the data transmission request, and the receiver had a data transmission with User C six months prior to the data transmission request. In that case, User C can be selected as the third party for calculating the indirect confidence level.

The indirect confidence level can be calculated based on a number of data transmissions and an amount of data transmitted between the receiver and the third party, and a number of data transmissions and an amount of data transmitted between the sender and the third party. In some instances, the indirect confidence level between the sender and the receiver is based on a direct confidence level between the sender and the third party, and a direct confidence level between the receiver and the third party. For example, a direct confidence level and a direct trust coefficient between the sender and the third party, denoted as C_{direct,1} and T_{direct,1}, respectively, can be determined as described at 202. Similarly, a direct confidence level and a direct trust coefficient between the receiver and the third party, denoted as C_{direct,2} and T_{direct,2}, respectively, can be determined as described at 202. The indirect confidence level C indirect between the sender and the receiver can be determined based on C_{direct,1}, C_{direct,2}, T_{direct,1}, and/or T_{direct,2}. For example, C_{indirect}=max(C_{direct,1}, C_{direct,2}), that is, the indirect confidence level between the sender and the receiver is a larger value of the direct confidence level between the sender and the third party and the direct confidence level between the receiver and the third party. Other mathematical functions can also be used for calculating the indirect confidence level, for example, C_{indirect}=max(T_{direct,1}*C_{direct,1}, T_{direct,2}*C_{direct,2}) or a weighted average C_{indirect}=W₁*C_{direct,1}+W₂*C_{direct,2}, where W₁ and W₂ are weighting values. In some cases, an indirect trust coefficient T_{indirect} between the sender and the receiver can be determined based on the direct trust coefficients T_{direct,1} and T_{direct,2}, for example, T_{indirect}=max(T_{direct,1} T_{direct,2}). From 204, method 200 proceeds to 206.

At 206, the server determines an overall confidence level between the sender and the receiver based on the direct and indirect confidence levels determined at 202 and 204. In some instances, the overall confidence level is determined based on not only data transmissions that occurred between the sender and the receiver, but also data transmissions that occurred between the sender and the third party and between the receiver and the third party. In some cases, if the direct or indirect confidence level does not exist, a zero value can be assigned. For example, the overall confidence level Cₒᵥₑᵣₐₗₗ can be determined by Cₒᵥₑᵣₐₗₗ=max (C_{direct}, C_{indirect}). In some cases, the overall confidence level can be a weighted sum of the direct and indirect confidence levels, such as Cₒᵥₑᵣₐₗₗ=W₁*C_{direct}+W₂*C_{indirect}, where the weights W₁ and W₂ can be any numbers statically or dynamically configured by the system operator, the sender, the receiver, or others. In some instances, the weights W₁ and W₂ can be respectively set to the trust coefficients T_{direct} and T_{indirect} determined at 202 and 204, and Cₒᵥₑᵣₐₗₗ=T_{direct}*C_{direct}+T_{indirect}*C_{indirect}. Other mathematical functions can also be used to calculate the overall confidence level. In some implementations, if the sender and the receiver have a non-zero direct confidence level, the overall confidence level can be set to the direct confidence level without calculating the indirect confidence level. After 206, method 200 stops.

Returning to FIG. 1, from 104, method 100 proceeds to 106.

At 106, the server selects a data transmission protection mechanism based on the overall confidence level between the sender and the receiver. In some implementations, if the data amount to be transmitted from the sender to the receiver is more than the overall confidence level, the sender or the receiver is authenticated (for example, the sender or the receiver is required to enter authentication information such as passwords) before the data can be transmitted from the sender to the receiver. If the data amount to be transmitted is equal to or less than the overall confidence level, the data is transmitted without the sender and/or the receiver being authenticated. If the sender and the receiver do not have an overall confidence level or have a zero overall confidence level (for example, because of no prior data transmissions between the sender and the receiver and no third party determined to have had data transmissions with both the sender and the receiver), the sender or the receiver is authenticated.

In some implementations, the authentication can be performed by the server, the sender's user computing device, or the receiver's user computing device or a combination of these computing devices. For example, when the sender or the receiver enters the authentication information on a respective user computing device, the entered information can be transmitted to the server so that the server can perform the authentication. In some cases, the sender's user computing device or the receiver's user computing device can verify the entered authentication information without involving the server. The sender's user computing device or the receiver's user computing device can indicate the authentication result to the server. In some implementations, the sender, the receiver, or both can be authenticated. From 106, method 100 proceeds to 108.

At 108, the data transmission is performed based on the selected data transmission authentication procedure. As previously described, if the data amount to be transmitted is equal to or less than the overall confidence level, the data is transmitted without authenticating the sender, the receiver, or both the sender and the receiver. Otherwise, the sender, or the receiver, or both the sender and the receiver authenticated. For example, the overall confidence level between the sender and the receiver is 10 GB. If the amount of data to be transmitted is 1 GB, then no authentication needs to be performed for the data transmission. However, if the amount of data to be transmitted is 20 GB, authentication is performed for the sender, the receiver, or both the sender and the receiver before the data transmission.

In some implementations, the data can be transmitted through the server, or directly from the sender's user computing device to the receiver's user computing device. For example, after the server receives the data transmission request from the sender's user computing device, if the server determines that the amount of data to be transmitted is more than the overall confidence level, the server can send an authentication request to the sender's user computing device, for instance, by rendering or initiating rendering of a window on a user interface of the sender's user computing device for the sender to enter authentication information. In some cases, the rendered window can indicate a warning message that the sender seldom or never engaged in data transmissions with the receiver. The server or the sender's user computing device can verify the entered authentication information. If the entered authentication information is correct, the sender's user computing device can start the data transmission to the receiver's user computing device. In some cases, the server can initiate the data transmission by sending a message to the sender's user computing device indicating that the sender's computing device can start the data transmission. The sender's user computing device can send the data to the server and the server can store the data before the receiver has been authenticated. The server can also send an authentication request to the receiver's user computing device. For example, an icon can be displayed on a user interface of the receiver's user computing device to notify the receiver of the pending authentication request. The user can click on the icon or open an application associated with the data transmission, and a window can be rendered on the user interface of the receiver's user computing device for the receiver to enter authentication information. In some cases, the rendered window can also indicate a warning message that the receiver seldom or never engaged in data transactions with the sender. After the server or the receiver's user computing device successfully verifies the authentication information, the server can forward the stored data to the receiver's user computing device. After 108, method 100 stops.

In some implementations, the described approach can also be used for a fund transfer, where the sender is a payer, the receiver is a payee, and the amount of data is considered to be an amount of funds to be transferred. For example, the payer can send a fund transfer request to the server. The request can indicate an amount of funds to be transferred and the payee's identity. The server can determine a direct confidence level between the payer and the payee based on records of prior fund transfers between the payer and the payee. The server can also determine if a third party had prior fund transfers with both the payee and the payer. Based on this determination, the server can determine an indirect confidence level based on records of prior fund transfers between the third party and the payee and between the third party and the payer. An overall confidence level between the payer and the payee can be determined based on the direct and indirect confidence levels. If the amount of funds to be transferred is less than the overall confidence level, the fund transfer can be performed without authenticating the payer and the payee. Otherwise, the fund transfer is performed after authenticating the payer and/or the payee. For example, consider an overall confidence level between the payer and the payee to be $1,000. If the amount of funds to be transferred is $100, then no authentication is performed for fund transfer. However, if the amount of funds to be transferred is $2,000, authentication is performed for the payer, the payee, or both the payer and the payee before the fund transfer. In some cases, a warning message can be displayed on the payer's user computing device, the payee's user computing device, or both user computing devices to remind the payer, the payee, or both the payer and payee that the payee and the payer seldom or never have engaged in fund transfers.

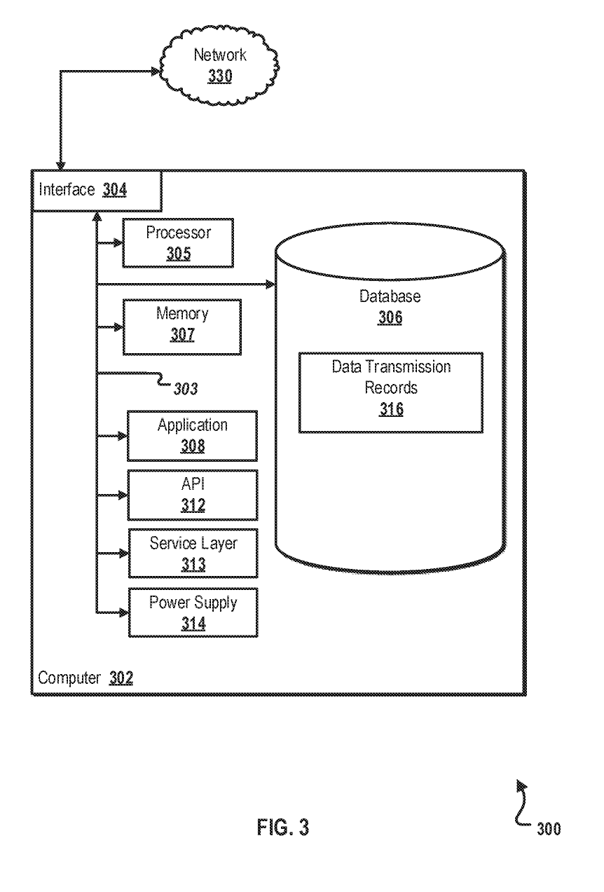

FIG. 3 is a block diagram of an example computer system 300 used to provide computational functionalities associated with described algorithms, methods, functions, processes, flows, and procedures, as described in the instant disclosure, according to an implementation of the present disclosure. The illustrated computer 302 is intended to encompass any computing device such as a server, desktop computer, laptop/notebook computer, wireless data port, smart phone, personal data assistant (PDA), tablet computing device, one or more processors within these devices, or any other suitable processing device, including physical or virtual instances (or both) of the computing device. Additionally, the computer 302 may comprise a computer that includes an input device, such as a keypad, keyboard, touch screen, or other device that can accept user information, and an output device that conveys information associated with the operation of the computer 302, including digital data, visual, or audio information (or a combination of information), or a graphical user interface (GUI).

The computer 302 can serve in a role as a client, network component, a server, a database or other persistency, or any other component (or a combination of roles) of a computer system for performing the subject matter described in the instant disclosure. The illustrated computer 302 is communicably coupled with a network 330. In some implementations, one or more components of the computer 302 may be configured to operate within environments, including cloud-computing-based, local, global, or other environment (or a combination of environments).

At a high level, the computer 302 is an electronic computing device operable to receive, transmit, process, store, or manage data and information associated with the described subject matter. According to some implementations, the computer 302 may also include or be communicably coupled with an application server, e-mail server, web server, caching server, streaming data server, or other server (or a combination of servers).

The computer 302 can receive requests over network 330 from a client application (for example, executing on another computer 302) and respond to the received requests by processing the received requests using an appropriate software application(s). In addition, requests may also be sent to the computer 302 from internal users (for example, from a command console or by other appropriate access method), external or third-parties, other automated applications, as well as any other appropriate entities, individuals, systems, or computers.

Each of the components of the computer 302 can communicate using a system bus 303. In some implementations, any or all of the components of the computer 302, hardware or software (or a combination of both hardware and software), may interface with each other or the interface 304 (or a combination of both), over the system bus 303 using an application programming interface (API) 312 or a service layer 313 (or a combination of the API 312 and service layer 313). The API 312 may include specifications for routines, data structures, and object classes. The API 312 may be either computer-language independent or dependent and refer to a complete interface, a single function, or even a set of APIs. The service layer 313 provides software services to the computer 302 or other components (whether or not illustrated) that are communicably coupled to the computer 302. The functionality of the computer 302 may be accessible for all service consumers using this service layer. Software services, such as those provided by the service layer 313, provide reusable, defined functionalities through a defined interface. For example, the interface may be software written in JAVA, C++, or other suitable language providing data in extensible markup language (XML) format or other suitable format. While illustrated as an integrated component of the computer 302, alternative implementations may illustrate the API 312 or the service layer 313 as stand-alone components in relation to other components of the computer 302 or other components (whether or not illustrated) that are communicably coupled to the computer 302. Moreover, any or all parts of the API 312 or the service layer 313 may be implemented as child or sub-modules of another software module, enterprise application, or hardware module without departing from the scope of this disclosure.

The computer 302 includes an interface 304. Although illustrated as a single interface 304 in FIG. 3, two or more interfaces 304 may be used according to particular needs, desires, or particular implementations of the computer 302. The interface 304 is used by the computer 302 for communicating with other systems that are connected to the network 330 (whether illustrated or not) in a distributed environment. Generally, the interface 304 comprises logic encoded in software or hardware (or a combination of software and hardware) and is operable to communicate with the network 330. More specifically, the interface 304 may comprise software supporting one or more communication protocols associated with communications such that the network 330 or interface's hardware is operable to communicate physical signals within and outside of the illustrated computer 302.

The computer 302 includes a processor 305. Although illustrated as a single processor 305 in FIG. 3, two or more processors may be used according to particular needs, desires, or particular implementations of the computer 302. Generally, the processor 305 executes instructions and manipulates data to perform the operations of the computer 302 and any algorithms, methods, functions, processes, flows, and procedures as described in the instant disclosure.

The computer 302 also includes a database 306 that can hold data for the computer 302 or other components (or a combination of both) that can be connected to the network 330 (whether illustrated or not). For example, database 306 can be an in-memory, conventional, or other type of database storing data consistent with this disclosure. In some implementations, database 306 can be a combination of two or more different database types (for example, a hybrid in-memory and conventional database) according to particular needs, desires, or particular implementations of the computer 302 and the described functionality. Although illustrated as a single database 306 in FIG. 3, two or more databases (of the same or combination of types) can be used according to particular needs, desires, or particular implementations of the computer 302 and the described functionality. While database 306 is illustrated as an integral component of the computer 302, in alternative implementations, database 306 can be external to the computer 302. As illustrated, the database 306 holds previously described data transmission records 316.

The computer 302 also includes a memory 307 that can hold data for the computer 302 or other components (or a combination of both) that can be connected to the network 330 (whether illustrated or not). Memory 307 can store any data consistent with this disclosure. In some implementations, memory 307 can be a combination of two or more different types of memory (for example, a combination of semiconductor and magnetic storage) according to particular needs, desires, or particular implementations of the computer 302 and the described functionality. Although illustrated as a single memory 307 in FIG. 3, two or more memories 307 (of the same or combination of types) can be used according to particular needs, desires, or particular implementations of the computer 302 and the described functionality. While memory 307 is illustrated as an integral component of the computer 302, in alternative implementations, memory 307 can be external to the computer 302.

The application 308 is an algorithmic software engine providing functionality according to particular needs, desires, or particular implementations of the computer 302, particularly with respect to functionality described in this disclosure. For example, application 308 can serve as one or more components, modules, or applications. Further, although illustrated as a single application 308, the application 308 may be implemented as multiple applications 308 on the computer 302. In addition, although illustrated as integral to the computer 302, in alternative implementations, the application 308 can be external to the computer 302.

The computer 302 can also include a power supply 314. The power supply 314 can include a rechargeable or non-rechargeable battery that can be configured to be either user- or non-user-replaceable. In some implementations, the power supply 314 can include power-conversion or management circuits (including recharging, standby, or other power management functionality). In some implementations, the power-supply 314 can include a power plug to allow the computer 302 to be plugged into a wall socket or other power source to, for example, power the computer 302 or recharge a rechargeable battery.

There may be any number of computers 302 associated with, or external to, a computer system containing computer 302, each computer 302 communicating over network 330. Further, the term “client,” “user,” and other appropriate terminology may be used interchangeably, as appropriate, without departing from the scope of this disclosure. Moreover, this disclosure contemplates that many users may use one computer 302, or that one user may use multiple computers 302.

Described implementations of the subject matter can include one or more features, alone or in combination.

For example, in a first implementation, a computer-implemented method, comprising: receiving a request for a data transmission between a sender and a receiver, the request including an amount of data associated with the data transmission; determining an overall confidence level between the receiver and the sender; selecting a data transmission protection mechanism based on the overall confidence level between the receiver and the sender; and performing the data transmission based on the selected data transmission protection mechanism.

The foregoing and other described implementations can each, optionally, include one or more of the following features:

A first feature, combinable with any of the following features, wherein the overall confidence level is determined based on at least one of a direct confidence level or an indirect confidence level.

A second feature, combinable with any of the previous or following features, wherein the direct confidence level is determined based on a number of prior data transmissions between the sender and the receiver that occurred during a time period and data amounts of the prior data transmissions between the sender and the receiver.

A third feature, combinable with any of the previous or following features, wherein the indirect confidence level is determined by: determining that a third party that had prior data transmissions with both the sender and the receiver during a time period; and determining the indirect confidence level based on a number of prior data transmissions between the sender and the third party that occurred during the time period, amounts of data associated with the prior data transmissions between the sender and the third party, a number of prior data transmissions between the receiver and the third party that occurred during the time period, and amounts of data associated with the prior data transmissions between the receiver and the third party.

A fourth feature, combinable with any of the previous or following features, wherein performing the data transmission based on the selected data transmission protection mechanism includes: performing the data transmission without authenticating the sender and the receiver if the amount of data is equal to or lower than the overall confidence level; and authenticating at least one of the sender or the receiver before the data transmission if the amount of data is higher than the overall confidence level.

A fifth feature, combinable with any of the previous or following features, wherein performing the data transmission based on the selected data transmission protection mechanism includes sending a warning message to the sender if the amount of data is higher than the overall confidence level.

A sixth feature, combinable with any of the previous or following features, wherein the data transmission is associated with a fund transfer, the amount of data is a fund amount associated with the fund transfer, the sender is a payer, and the receiver is a payee.

In a second implementation, a non-transitory, computer-readable medium storing one or more instructions executable by a computer system to perform operations comprising: receiving a request for a data transmission between a sender and a receiver, the request including an amount of data associated with the data transmission; determining an overall confidence level between the receiver and the sender; selecting a data transmission protection mechanism based on the overall confidence level between the receiver and the sender; and performing the data transmission based on the selected data transmission protection mechanism.

The foregoing and other described implementations can each, optionally, include one or more of the following features:

A first feature, combinable with any of the following features, wherein the overall confidence level is determined based on at least one of a direct confidence level or an indirect confidence level.

A second feature, combinable with any of the previous or following features, wherein the direct confidence level is determined based on a number of prior data transmissions between the sender and the receiver that occurred during a time period and data amounts of the prior data transmissions between the sender and the receiver.

A third feature, combinable with any of the previous or following features, wherein the indirect confidence level is determined by: determining that a third party that had prior data transmissions with both the sender and the receiver during a time period; and determining the indirect confidence level based on a number of prior data transmissions between the sender and the third party that occurred during the time period, amounts of data associated with the prior data transmissions between the sender and the third party, a number of prior data transmissions between the receiver and the third party that occurred during the time period, and amounts of data associated with the prior data transmissions between the receiver and the third party.

A fourth feature, combinable with any of the previous or following features, wherein performing the data transmission based on the selected data transmission protection mechanism includes: performing the data transmission without authenticating the sender and the receiver if the amount of data is equal to or lower than the overall confidence level; and authenticating at least one of the sender or the receiver before the data transmission if the amount of data is higher than the overall confidence level.

A fifth feature, combinable with any of the previous or following features, wherein performing the data transmission based on the selected data transmission protection mechanism includes sending a warning message to the sender if the amount of data is higher than the overall confidence level.

A sixth feature, combinable with any of the previous or following features, wherein the data transmission is associated with a fund transfer, the amount of data is a fund amount associated with the fund transfer, the sender is a payer, and the receiver is a payee.

In a third implementation, a computer-implemented system, comprising: one or more computers; and one or more computer memory devices interoperably coupled with the one or more computers and having tangible, non-transitory, machine-readable media storing instructions that, when executed by the one or more computers, perform operations comprising: receiving a request for a data transmission between a sender and a receiver, the request including an amount of data associated with the data transmission; determining an overall confidence level between the receiver and the sender; selecting a data transmission protection mechanism based on the overall confidence level between the receiver and the sender; and performing the data transmission based on the selected data transmission protection mechanism.

The foregoing and other described implementations can each, optionally, include one or more of the following features:

A first feature, combinable with any of the following features, wherein the overall confidence level is determined based on at least one of a direct confidence level or an indirect confidence level.

A second feature, combinable with any of the previous or following features, wherein the direct confidence level is determined based on a number of prior data transmissions between the sender and the receiver that occurred during a time period and data amounts of the prior data transmissions between the sender and the receiver.

A third feature, combinable with any of the previous or following features, wherein the indirect confidence level is determined by: determining that a third party that had prior data transmissions with both the sender and the receiver during a time period; and determining the indirect confidence level based on a number of prior data transmissions between the sender and the third party that occurred during the time period, amounts of data associated with the prior data transmissions between the sender and the third party, a number of prior data transmissions between the receiver and the third party that occurred during the time period, and amounts of data associated with the prior data transmissions between the receiver and the third party.

A fourth feature, combinable with any of the previous or following features, wherein performing the data transmission based on the selected data transmission protection mechanism includes: performing the data transmission without authenticating the sender and the receiver if the amount of data is equal to or lower than the overall confidence level; and authenticating at least one of the sender or the receiver before the data transmission if the amount of data is higher than the overall confidence level.

A fifth feature, combinable with any of the previous or following features, wherein performing the data transmission based on the selected data transmission protection mechanism includes sending a warning message to the sender if the amount of data is higher than the overall confidence level.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data may be less than 1 ms, less than 1 sec., or less than 5 secs. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components, as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data includes all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital video disc (DVD), CD-ROM, DVD+/-R, DVD-RAM, DVD-ROM, HD-DVD, and BLURAY, and other optical memory technologies. The memory may store various objects or data, including caches, classes, frameworks, applications, modules, backup data, jobs, web pages, web page templates, data structures, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain this disclosure. Other changes, substitutions, and alterations are also possible without departing from the spirit and scope of this disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
receiving a request for a data transmission between a sender and a receiver, the request including an amount of data associated with the data transmission;
determining an overall confidence level between the receiver and the sender;
selecting a data transmission protection mechanism based on the overall confidence level between the receiver and the sender; and
performing the data transmission based on the selected data transmission protection mechanism.

2. The computer-implemented method of claim 1, wherein the overall confidence level is determined based on at least one of a direct confidence level or an indirect confidence level.

3. The computer-implemented method of claim 2, wherein the direct confidence level is determined based on a number of prior data transmissions between the sender and the receiver that occurred during a time period and data amounts of the prior data transmissions between the sender and the receiver.

4. The computer-implemented method of claim 2, wherein the indirect confidence level is determined by:
determining that a third party that had prior data transmissions with both the sender and the receiver during a time period; and
determining the indirect confidence level based on a number of prior data transmissions between the sender and the third party that occurred during the time period, amounts of data associated with the prior data transmissions between the sender and the third party, a number of prior data transmissions between the receiver and the third party that occurred during the time period, and amounts of data associated with the prior data transmissions between the receiver and the third party.

5. The computer-implemented method of claim 1, wherein performing the data transmission based on the selected data transmission protection mechanism includes:
performing the data transmission without authenticating the sender and the receiver if the amount of data is equal to or lower than the overall confidence level; and
authenticating at least one of the sender or the receiver before the data transmission if the amount of data is higher than the overall confidence level.

6. The computer-implemented method of claim 1, wherein performing the data transmission based on the selected data transmission protection mechanism includes sending a warning message to the sender if the amount of data is higher than the overall confidence level.

7. The computer-implemented method of claim 1, wherein the data transmission is associated with a fund transfer, the amount of data is a fund amount associated with the fund transfer, the sender is a payer, and the receiver is a payee.

8. A non-transitory, computer-readable medium storing one or more instructions executable by a computer system to perform operations comprising:
receiving a request for a data transmission between a sender and a receiver, the request including an amount of data associated with the data transmission;
determining an overall confidence level between the receiver and the sender;
selecting a data transmission protection mechanism based on the overall confidence level between the receiver and the sender; and
performing the data transmission based on the selected data transmission protection mechanism.

9. The non-transitory, computer-readable medium of claim 8, wherein the overall confidence level is determined based on at least one of a direct confidence level or an indirect confidence level.

10. The non-transitory, computer-readable medium of claim 9, wherein the direct confidence level is determined based on a number of prior data transmissions between the sender and the receiver that occurred during a time period and data amounts of the prior data transmissions between the sender and the receiver.

11. The non-transitory, computer-readable medium of claim 9, wherein the indirect confidence level is determined by:
determining that a third party that had prior data transmissions with both the sender and the receiver during a time period; and
determining the indirect confidence level based on a number of prior data transmissions between the sender and the third party that occurred during the time period, amounts of data associated with the prior data transmissions between the sender and the third party, a number of prior data transmissions between the receiver and the third party that occurred during the time period, and amounts of data associated with the prior data transmissions between the receiver and the third party.

12. The non-transitory, computer-readable medium of claim 8, wherein performing the data transmission based on the selected data transmission protection mechanism includes:
performing the data transmission without authenticating the sender and the receiver if the amount of data is equal to or lower than the overall confidence level; and
authenticating at least one of the sender or the receiver before the data transmission if the amount of data is higher than the overall confidence level.

13. The non-transitory, computer-readable medium of claim 8, wherein performing the data transmission based on the selected data transmission protection mechanism includes sending a warning message to the sender if the amount of data is higher than the overall confidence level.

14. The non-transitory, computer-readable medium of claim 8, wherein the data transmission is associated with a fund transfer, the amount of data is a fund amount associated with the fund transfer, the sender is a payer, and the receiver is a payee.

15. A computer-implemented system, comprising:
one or more computers; and
one or more computer memory devices interoperably coupled with the one or more computers and having tangible, non-transitory, machine-readable media storing instructions that, when executed by the one or more computers, perform operations comprising:
receiving a request for a data transmission between a sender and a receiver, the request including an amount of data associated with the data transmission;
determining an overall confidence level between the receiver and the sender;
selecting a data transmission protection mechanism based on the overall confidence level between the receiver and the sender; and
performing the data transmission based on the selected data transmission protection mechanism.

16. The computer-implemented system of claim 15, wherein the overall confidence level is determined based on at least one of a direct confidence level or an indirect confidence level.

17. The computer-implemented system of claim 16, wherein the direct confidence level is determined based on a number of prior data transmissions between the sender and the receiver that occurred during a time period and data amounts of the prior data transmissions between the sender and the receiver.

18. The computer-implemented system of claim 16, wherein the indirect confidence level is determined by:
determining that a third party that had prior data transmissions with both the sender and the receiver during a time period; and
determining the indirect confidence level based on a number of prior data transmissions between the sender and the third party that occurred during the time period, amounts of data associated with the prior data transmissions between the sender and the third party, a number of prior data transmissions between the receiver and the third party that occurred during the time period, and amounts of data associated with the prior data transmissions between the receiver and the third party.

19. The computer-implemented system of claim 15, wherein performing the data transmission based on the selected data transmission protection mechanism includes:
performing the data transmission without authenticating the sender and the receiver if the amount of data is equal to or lower than the overall confidence level; and
authenticating at least one of the sender or the receiver before the data transmission if the amount of data is higher than the overall confidence level.

20. The computer-implemented system of claim 15, wherein performing the data transmission based on the selected data transmission protection mechanism includes sending a warning message to the sender if the amount of data is higher than the overall confidence level.
